(19) United States
(12) Patent Application Publication
(10) Pub. No.: US 2006/0077621 A1
(43) Pub. Date: Apr. 13, 2006

(54) Pivoting LapTop Computer

(75) Inventor: Aminmohamed Adatia, Ottawa (CA)

Correspondence Address: AMINMOHAMED ADATIA, 66 PINEGLEN CRESCENT, OTTAWA, ON, K2G OG8, CA

(73) Assignee: Aminmohamed Adatia, Ottawa (CA)

(21) Appl. No.: 10/905,289

(22) Filed: Dec. 23, 2004

(30) Foreign Application Priority Data
Oct. 12, 2004 (CA) 2482292

(51) Int. Cl. G06F 1/16

(52) U.S. Cl. 361/681

(57) ABSTRACT

The Pivoting Laptop Computer allows for the display to be in either the landscape or the portrait mode.

### DESCRIPTION

Traditional Laptop computers have a display screen only in the landscape (width is greater than height) mode. The Pivoting Laptop Computer design allows for the screen to pivot giving a display screen in the portrait (height is greater than width) mode. FIG. 2 shows the traditional landscape mode and FIG. 3 shows the pivoted portrait mode.

### BRIEF DESCRIPTION OF THE DRAWINGS

FIG. 1 shows the Laptop Computer with the cover (which has the display unit) closed.

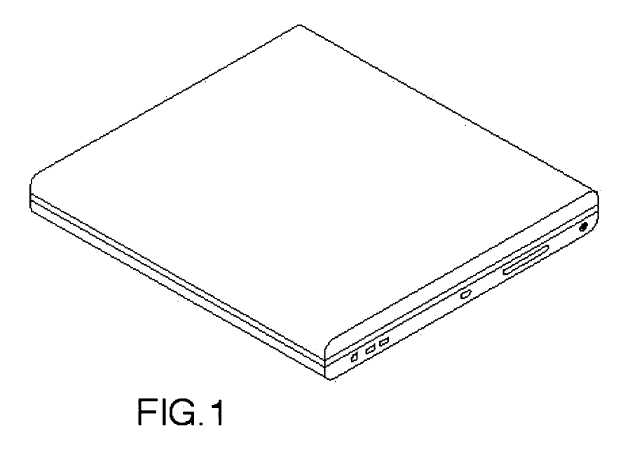

FIG. 2 is the view of the Laptop Computer with the display in the traditional landscape (width greater than height) mode.

FIG. 3 is the view of the Laptop Computer with the display pivoted to the portrait (height greater than width) mode.

FIG. 4 shows the display unit, in landscape mode, at the maximum vertical travel position along the support hinges prior to the pivot rotation.

FIG. 5 show the display unit during the pivot rotation from landscape to portrait mode.

FIG. 6 shows the display unit in portrait mode still at the maximum vertical travel position along the support hinges. Sliding the display unit down towards the computer base completes the pivot as shown in FIG. 3.

FIG. 7 shows the exploded perspective view of the vertical slide and the pivot mechanisms.

FIG. 8 shows the pivot mechanism.

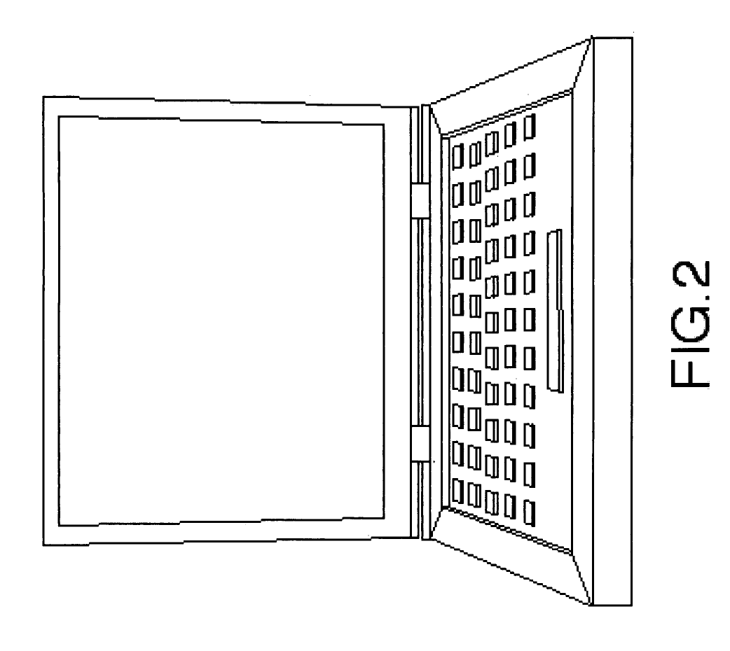

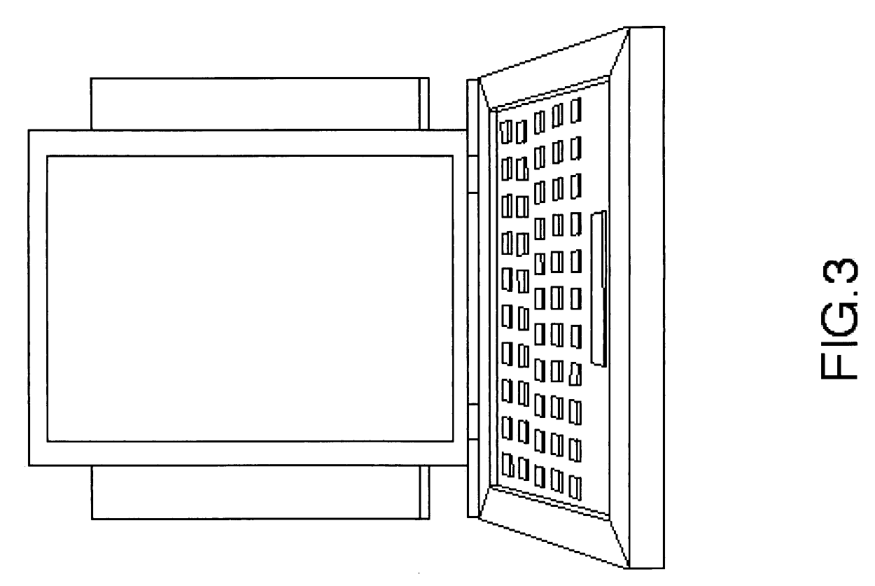

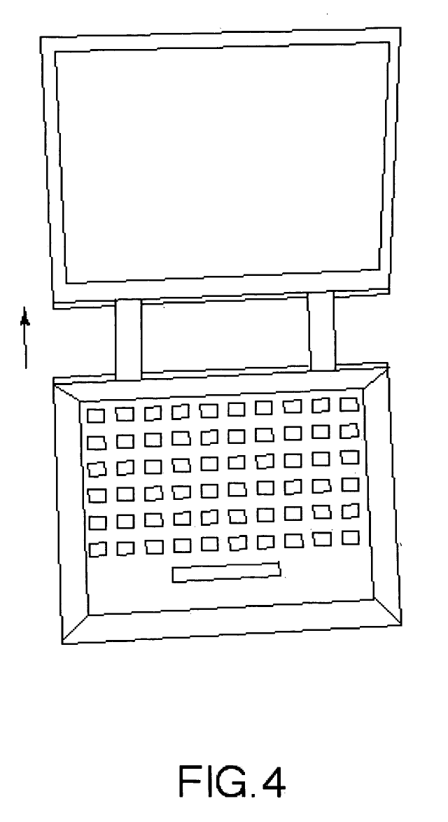

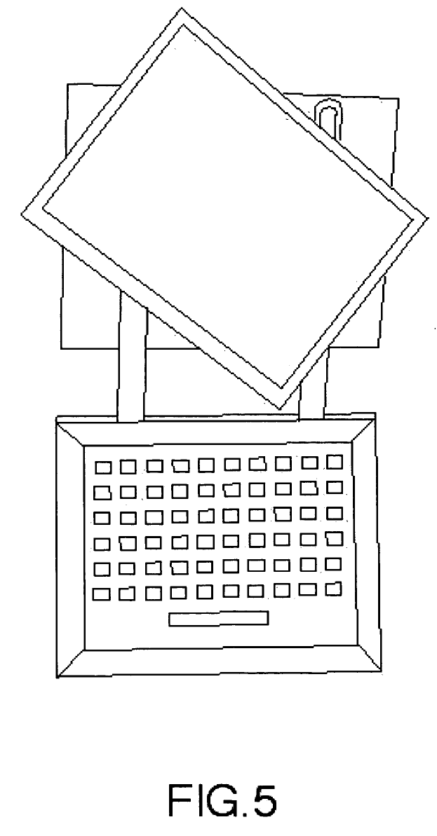

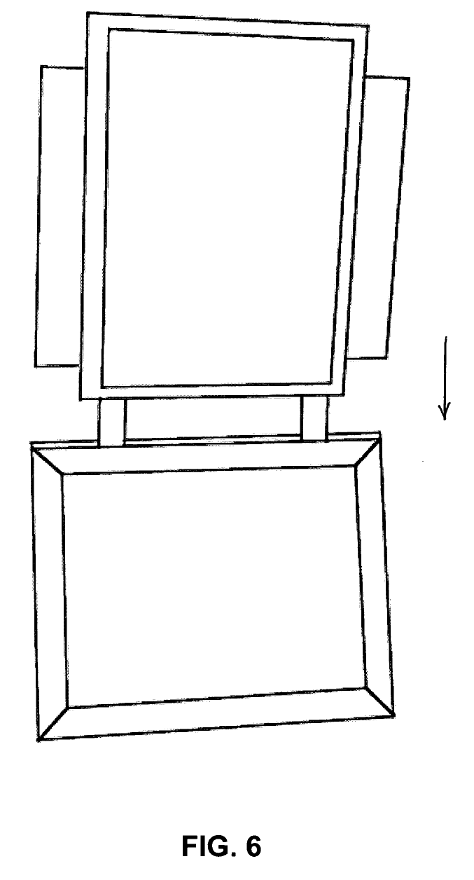

The following describes the process of pivoting the Laptop display from the Landscape Mode to the Portrait Mode. FIG. 2 shows the Laptop display in the landscape configuration, as it would be at start-up. To begin the pivot process, the display screen would slide up along the vertical supports which form part of the hinge that holds the display unit and cover for the Laptop computer as shown in FIG. 4. Once the display screen is at the maximum travel position, the display screen is pivoted as shown in FIG. 5 until it is in the portrait mode shown in FIG. 6. The display screen would then be slid down towards the computer case until it is again at the computer base. The display screen is now in the pivoted Portrait Mode as shown in FIG. 3.

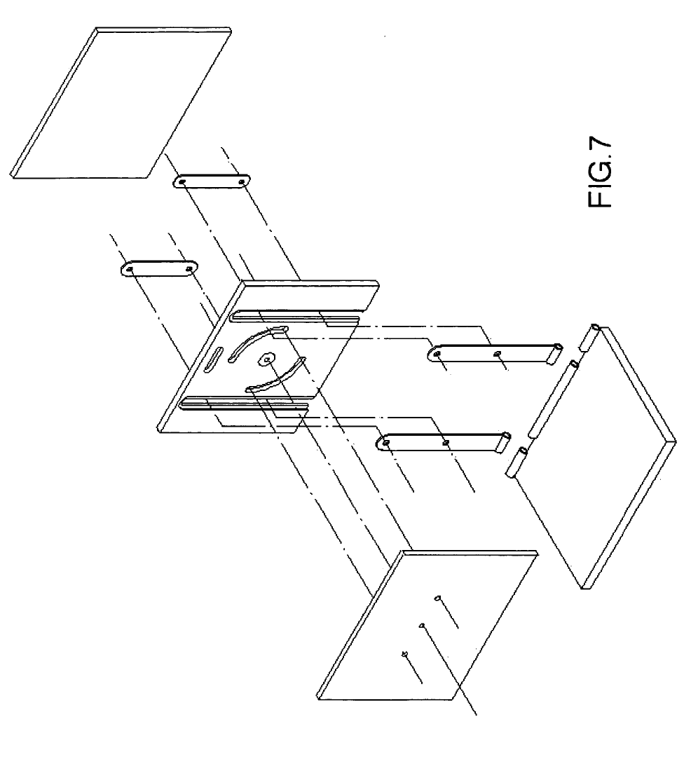

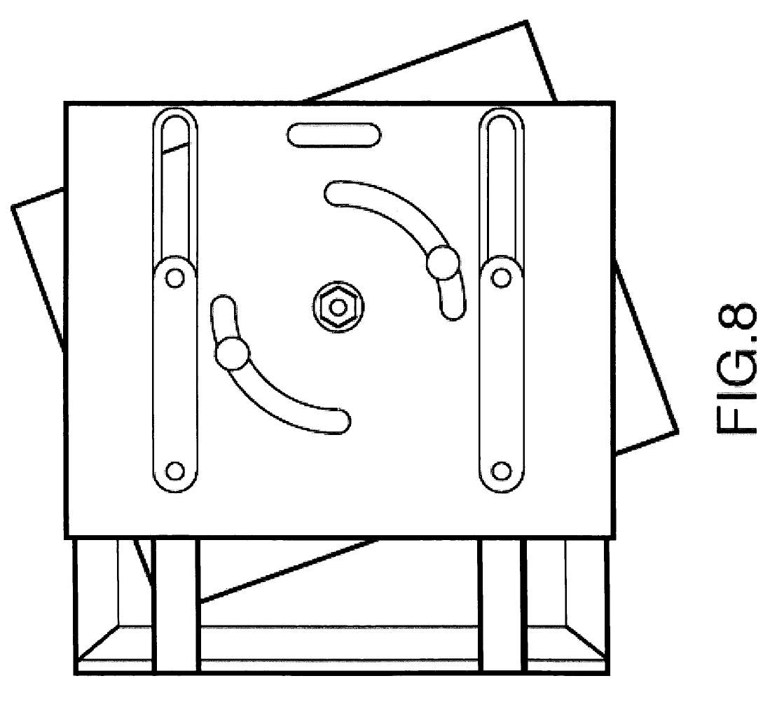

There are two mechanisms that facilitate the pivot of the display screen. The first is the vertical travel and the second is the pivot rotation. These are shown in FIG. 7 as an exploded perspective view. FIG. 8 shows the pivot mechanism and also the vertical travel mechanism. The vertical slides are mounted as extensions of the hinge that allows the screen to open from and close to the computer base (keyboard) as with any standard Laptop computer. The pivoting mechanism is at the centre with a nut and bolt holding the screen in place and the two grooves allowing for the pivoting rotation.

The embodiments of the invention in which an exclusive property or privilege is claimed are defined as follows:

1. A Pivoting Laptop Computer, which allows for the screen to pivot giving a display screen in the portrait (height is greater than width) mode from the traditional landscape (width is greater than height) mode. A Laptop Computer includes the description Notebook computer that is regarded as a physically smaller unit to the Laptop Computer.
